(19) United States
(12) Patent Application Publication
(10) Pub. No.: US 2012/0114122 A1
(43) Pub. Date: May 10, 2012

(54) SOURCE PROGRAMMING AND MANAGEMENT SYSTEM FOR LOCKS COMPRISING CONTACTLESS COMMUNICATION MEANS THAT CAN BE CONTROLLED BY A PORTABLE NFC TELEPHONE

(76) Inventor: Pascal Metivier, Feucherolles (FR)

(21) Appl. No.: 13/266,929

(22) PCT Filed: Apr. 28, 2010
(86) PCT No.: PCT/FR2010/050809

§ 371 Date: Jan. 9, 2012

(30) Foreign Application Priority Data
Apr. 30, 2009 (FR) 0952857

(51) Int. Cl. H04K 1/00

(52) U.S. Cl. 380/247

(57) ABSTRACT

The invention relates to a system comprising a lock (40) provided with NFC circuits, a mobile phone (32) also provided with NFC circuits, a remote lock management site (18), and a mobile network operator (20). For each lock, the management site generates a unique random algorithm, a unique identifier (PUID) and transport keys and transmits the identifier and the transport keys to a lock manufacturer (16). The mobile network operator receives a unique lock identifier (PUID) from the user and transmits same to the handling site which, in return, transmits the unique random algorithm, the cryptographic key, the transport key and the user key corresponding to the lock to the phone. The phone implements the initial programming of the lock, by loading the unique random algorithm, the cryptographic key and the user key onto the lock and, subsequently, the phone activates a secure cryptographic procedure.

The invention relates to locks controlled by means of a hand-held object acting as a key, which cooperates with the lock by way of a non-galvanic mutual coupling of the NFC (Near Field Communication) type.

Such hand-held object may be a contactless card or badge, but it may also be a portable telephone equipped with a NFC chip and a NFC antenna, with the telephone SIM card being used as a security element.

The NFC technology consists in coupling the hand-held object and the lock to each other by varying a magnetic field produced by a coil (such technic being referred to as “induction process”). The lock comprises for that purpose an inductive circuit excited by an AC signal that produces a variable magnetic field, able to be detected over a range of at most a few centimeters. The hand-held object located within this range receives the energy of the field (which permits in particular the remote power supply of the hand-held object, the latter having generally no power source of its own) and modulates an inner charge. Such modulation, coded by various data coming from the hand-held object (identifier, encryption key, etc.), is then detected by the lock, which establishes the desired bidirectional communication.

Various coding and encryption techniques exist for securing the contactless communication between the hand-held object and the lock, and protecting the latter against any risk of fraud.

Such protection techniques use algorithms and keys that are implemented in the lock and in the cards or badges to be used with the latter.

When a portable telephone equipped with NFC communication means is used as a key, the risks may be increased insofar as this telephone is an unmarked object, which moreover is connected to the public network of the mobile operator and is not a specific tailored object as in the case of the card or badge.

The object of the invention is to propose a technic of programming and management of NFC-type contactless locks, having an increased level of security and adapted in particular to the use of a portable telephone provided with NFC circuits as a key for controlling this lock.

The principle of the invention consists in providing a unique algorithm, randomly generated for each lock at the time of fabrication of the latter, and stored by a non-public secured site. At the initial programming of the lock, the algorithm may be downloaded by a portable telephone from the secured site, after verification of all the conditions required to authenticate the user and the lock. Besides this unique algorithm, the telephone may download from the secured site other security elements such as cryptographic keys, identifiers . . . , operable to ensure, during the lock programming, the integration of all the security elements providing the desired maximum level of protection.

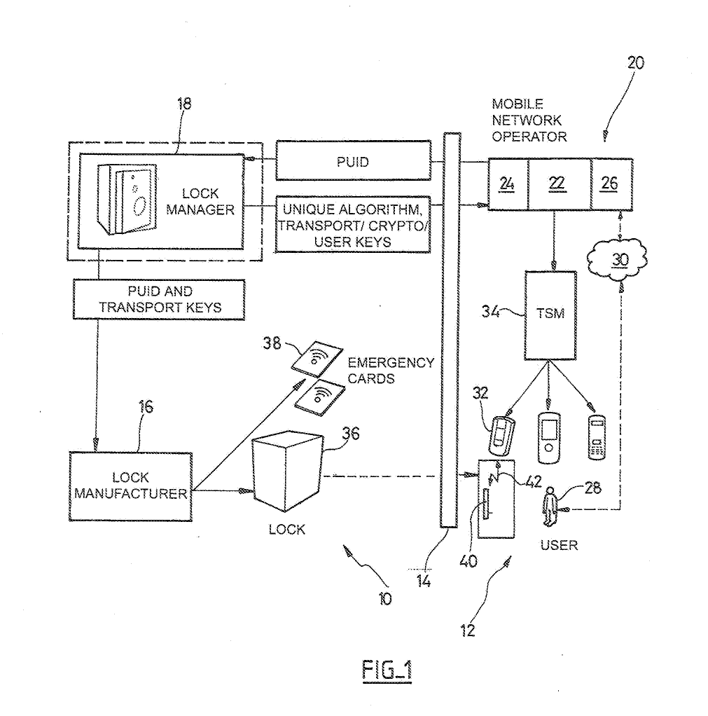

An exemplary embodiment of the invention is described with reference to FIG. 1.

The principle of secured management of the invention is based on the partition between two entity groups 10, 12, capable of communicating with each other only in a restricted and secured manner, as symbolized by the screen 14.

The group 10 gathers secured specific entities, comprising the lock manufacturer 16 and a site 18 peculiar to the lock manager.

On the other hand, the group 12 gathers a number of user-side non-specific entities, with in particular a mobile network operator 20. This operator comprises a service provider module (bloc 22) that communicates, on the one hand (interface 24), with the secured site 18 and, on the other hand (interface 26), with a user 28, via a vanilla communication means 30, such as web, WAP “hotline”, etc.

The telephone 32 of the user 28 is interfaced with the service provider 22 of the mobile network operator via a trusted service manager (TSM) 34, operable to ensure in an efficient and secure manner the various data downloading and uploading operations between the remote management site 18 and the portable telephone 32 via the service provider 22 of the mobile network operator.

Indeed, in the case of a card or a badge, a significant part of the security is ensured by the physical delivering of this object to the lawful user, in the same way as the delivery of a set of keys. On the other hand, if the hand-held object is a portable telephone, it is an unmarked object, which in principle is not associated with a given lock. Of course, it comprises a SIM card that identifies the user and an IMEI identifier that uniquely identifies the telephone, but, at the beginning, the lock does not know those identifiers and is thus unable to recognize them when the telephone is brought near the lock.

It is therefore necessary, once the lock is installed, to conduct a so-called “programming” operation consisting in teaching the lock to identify any particular telephone that is presented to it as being the entitled user's one, and then to switch to a mode in which only this telephone is able to control the lock (such operation being of course repeatable for other telephones, if it is desired to entitle several persons).

The sequence of the various steps of the method according to the invention will now be described.

The secured management site 18 contains a cryptographic motor capable of generating for each lock to be fabricated a unique random algorithm, as well as a unique identifier and transport keys.

The unique random algorithm is added to the conventional cryptographic mechanism, and adds an additional security level to the existing cryptographic technics.

The unique identifier, referred to as PUID (Public Unique IDentifier), is a non-modifiable identifier permitting to recognize the lock in a unique and definitive manner between all the locks.

When the manufacturer 16 fabricates a lock, it receives from the management site 18, through a secured encrypted communication, the corresponding PUID identifier and the associated transport keys (such information can possibly be acquired as a whole in batches). It will be noted that the unique algorithm is not transmitted to the manufacturer 16 by the management site 18, which keeps it internally, nevertheless knowing to which PUID identifier it corresponds.

The manufacturer 16 then programs each lock 36 with its unique identifier and its corresponding transport key. It also programs so-called “emergency cards” 38 with the same transport key. Such cards will permit to operate the lock during its installation, using only simplified algorithms based on the provisional transport key, until the definitive programming, in which this key will be neutralized and replaced by a definitive cryptographic key.

The locks may then be sent so as to be installed by the user 28 at their definitive location 40.

Once the lock is installed, it has to be “programmed” so as to implement therein the algorithms, advanced cryptographic elements and definitive keys permitting to obtain the desired high level of security.

Such programming may be performed by means of a portable telephone 32 provided with NFC circuits, which can be coupled by a NFC bidirectional communication with the lock 40, as schematically shown by the wireless link 42.

To perform the programming, the user has to identify and register with the management site 18, which he/she contacts by any suitable means via the interface 26 of the mobile network operator. The user provides the operator 22 with the unique PUID identifier of the lock 40, such information being transmitted to the management site 18 by the secured interface 24. The management site 18 recognizes the PUID identifier in its database and sends back to the mobile network operator, via the secured interface 24: the unique algorithm of the lock, the cryptographic keys corresponding to this lock, as well as the corresponding transport key. The site also verifies that the telephone 32 used is actually a telephone provided with NFC features.

The exchanges between the telephone and the management site, as well as between the telephone and the lock, may be managed by means of a specific application of the “applet” type, previously downloaded by the telephone. Once loaded and activated, this applet will automatically implement the different steps required for the exchange of data with the management site 18 and for the programming of the lock 40, and that in a perfectly secured manner.

Once all the required data are loaded into the telephone 32, the user just needs to present the telephone in front of the lock 40 to be programmed, in order to establish the bidirectional NFC coupling 42.

The telephone firstly resets the lock by deactivating the transport key, which thus makes the emergency cards supplied with the lock inoperative. Thereafter, it uploads into the lock the elements required for the implementation of the security procedures, in particular the unique random algorithm, the definitive cryptographic key and the user key. The secured cryptographic procedure can then be activated, and the programming phase is terminated.

Advantageously, it is further proposed to the user, after he/she has accepted the definitive cryptographic key and loaded the latter as well as the user key into his/her telephone, to duplicate these keys onto one of the emergency cards 34.

For that purpose, the user has just to take one of the emergency cards located in the lock packaging and to apply it against his/her telephone in order to couple these two elements by NFC. The applet of the telephone will then be able to read the card content, to recognize within the latter the transport key (loaded at the time of the lock fabrication), and to verify that this key actually corresponds to the one transmitted by the manager 18 along with the definitive cryptographic key. If such is the case, the applet neutralizes the transport key and replaces it by the cryptographic key and a copy of the user key.

1. A system comprising:
at least one lock (40) provided with electronic circuits for NFC transmission/reception and with electric circuits for the control of locking/unlocking mechanical elements;
a portable telephone (32) provided with circuits enabling it to operate in NFC mode;
a remote lock management site (18);
a distinct site (16) of a lock manufacturer; and
a mobile network operator (20) interfaced with the management site (18), with the mobile telephone (32) and with a user (28),
said system being characterized in that:
the management site is capable of generating, for each lock, a unique random algorithm, a unique identifier (PUID) and a transport key, and of transmitting to the distinct site (16) of the lock manufacturer, for each fabricated lock, said unique identifier and said transport key;
the lock manufacturer is capable of programming each lock with its unique identifier and its corresponding transport key;
the mobile network operator (20) communicates with the management site via a secured interface (24), and with the mobile telephone (32) via a trusted service manager (34);
the mobile network operator is capable of receiving from the user a unique identifier (PUID) of a lock and of transmitting it to the management site for a preliminary recognition;
the management site is capable of transmitting back to the telephone, via said secured interface (24) of the mobile network operator and via said trusted service manager (34): the unique random algorithm, a cryptographic key, the transport key and a user key that correspond to this lock; and
the telephone comprises means for operating an initial programming of the lock by uploading into the lock the unique random algorithm, the cryptographic key and the user key, and by activating a secured cryptographic procedure.

2. The system according to claim 1, further comprising:
at least one emergency card (38) initially programmed by the lock manufacturer with said transport key, and
means for duplicating said cryptographic key and said user key onto the emergency card, after the user has accepted this cryptographic key and after the latter as well as the user key have been loaded into the telephone.

3. The system according to claim 2, wherein the means for duplicating the cryptographic key and the user key onto the emergency card comprise means for: reading the content of this emergency card; recognizing in the latter the transport key loaded at the time of the lock fabrication; verifying that this key actually corresponds to the one transmitted by the management site (18) along with the definitive cryptographic key; and if such is the case, neutralizing the transport key and replacing it by the cryptographic key and the user key.
